(19) United States
(12) Patent Application Publication
(10) Pub. No.: US 2006/0097635 A1
(43) Pub. Date: May 11, 2006

(54) Plasma display panel and method of manufacturing the same

(75) Inventors: Seung-Beom Seo, Suwon-si (KR); Seung-Uk Kwon, Suwon-si (KR)

Correspondence Address: MCGUIREWOODS, LLP, 1750 TYSONS BLVD, SUITE 1800, MCLEAN, VA, 22102, US

(73) Assignee: Samsung SDI Co., Ltd.

(21) Appl. No.: 11/269,562

(22) Filed: Nov. 9, 2005

(30) Foreign Application Priority Data
Nov. 10, 2004 (KR) 10-2004-0091529

(51) Int. Cl. H01J 17/49

(52) U.S. Cl. 313/582

(57) ABSTRACT

Provided is a blue phosphor layer that is arranged in discharge cells of a plasma display panel. The blue phosphor layer is formed by stacking two kinds of blue phosphor materials in a dual-layered structure.

### CROSS-REFERENCE TO RELATED APPLICATIONS

This application claims priority to and the benefit of Korean Patent Application No. 10-2004-0091529, filed on Nov. 10, 2004, which is hereby incorporated by reference for all purposes as if fully set forth herein.

### BACKGROUND OF THE INVENTION

1. Field of the Invention

The present invention relates to a plasma display panel and a method of manufacturing the same, and more particularly, to a plasma display panel including two blue phosphor materials to increase the panel's life span and light emission efficiency.

2. Discussion of the Background

Generally, a plasma display panel (PDP) displays images using a gas discharge. Applying a direct current (DC) or alternating current (AC) voltage to the PDP's electrodes generates the gas discharge, which emits ultraviolet rays, thereby exciting a phosphor material to emit light.

FIG. 1 is a schematic exploded perspective view of a conventional AC PDP.

Referring to FIG. 1, pairs of transparent X and Y display electrodes 3 and 4 are formed on a lower surface of a front substrate 11, and address electrodes 5 are formed on an upper surface of a rear substrate 12. A sustain discharge occurs between the X and Y electrode pairs. The X and Y display electrodes 3 and 4 and the address electrode 5 are formed in strip patterns, and they cross each other at substantially right angles when the front and rear substrates 11 and 12 are joined together.

A dielectric layer 14 and a protective layer 15 are sequentially stacked on the lower surface of the front substrate 11. Further, barrier ribs 17 are formed on an upper surface of a dielectric layer 14′ of the rear substrate 12, and cells 19 are defined by the barrier ribs 17. The discharge gas, which may include an inert gas such as Xe or Ne, is filled in the cells 19. Additionally, a phosphor material 18 is applied to sides of the barrier ribs 17 and on the dielectric layer 14′. A bus electrode 6 decreases the line resistance of the X and Y display electrodes 3 and 4.

In the PDP, applying an address voltage between an address electrode 5 and one display electrode generates an address discharge in a corresponding discharge cell. When positive ions accumulate on the dielectric layer 14 by the address voltage, the address discharge occurs. If the address voltage exceeds a threshold voltage, the discharge gas filled in the cells 19 generates plasma due to the discharge, and stable discharge may be maintained between the X and Y display electrodes 3 and 4. During the sustain discharge between an X and Y electrode, ultraviolet rays collide with the phosphor material 18 to emit light, thereby forming an image with the cells 19.

FIG. 2 is a cross-sectional view of an inner structure of the rear substrate of the PDP of FIG. 1.

Referring to FIG. 2, the address electrodes 5 and the dielectric layer 14′ are formed on the upper surface of the rear substrate 12, and the barrier ribs 17 are formed on the dielectric layer 14′. A red R, green G, or blue B cell is formed between two neighboring barrier ribs 17, and the phosphor material 18 is applied in the cells 19.

Generally, the blue phosphor material has the lowest light emission efficiency and the shortest life span of the red, green, and blue phosphor materials. Ba Mg Al₁₀O₇ (BAM blue phosphor material) or Ca₂ Mg SiO₆ (CMS blue phosphor material) may be used for the blue phosphor material. Of these two materials, BAM blue phosphor material has relatively higher light emission efficiency and a shorter life span. Additionally, CMS blue phosphor material has a low brightness. Therefore, using CMS blue phosphor material may increase the life span of the phosphor material, but the light emission efficiency may be low.

The Xe gas included in the discharge gas irradiates vacuum ultraviolet rays of two different wavelengths onto the phosphor material. For example, Xe gas irradiates 147 nm and 172 nm wavelength vacuum ultraviolet rays since the Xe gas may also include Xe₂ gas in addition to Xe gas. BAM blue phosphor material has high light emission efficiency with respect to the vacuum ultraviolet rays of two different wavelengths. However, CMS blue phosphor material has relatively high light emission efficiency with respect to the 147 nm wavelength vacuum ultraviolet rays (about 80% of the light emission efficiency of the BAM blue phosphor layer), but it has lower light emission efficiency with respect to the 172 nm wavelength vacuum ultraviolet rays (about 30% or less of the light emission efficiency of the BAM blue phosphor layer).

Further, with an increased content of Xe gas in the discharge gas, which improves light emission efficiency, the amount of emitted 172 nm wavelength vacuum ultraviolet rays also increases. Therefore, CMS blue phosphor material may not be useful in increasing the life span of the phosphor material when the content of the Xe gas is increased.

In order to solve the above problem, BAM blue phosphor material and CMS blue phosphor material may be mixed together. However, the mixed blue phosphor material provides light emission efficiency and life span characteristics that are the average of those of the BAM blue phosphor material and the CMS blue phosphor material. Therefore, the mixed blue phosphor material may actually degrade the PDP's quality.

### SUMMARY OF THE INVENTION

The present invention provides an improved PDP and a method of manufacturing the same.

The present invention also provides a PDP including a blue phosphor layer having improved light emission efficiency and life span, and a method of manufacturing the PDP.

The present invention also provides a PDP having an optimal amount of BAM blue phosphor material and CMS blue phosphor material, and a method of manufacturing the PDP.

Additional features of the invention will be set forth in the description which follows, and in part will be apparent from the description, or may be learned by practice of the invention.

The present invention discloses a PDP including a front substrate including a first display electrode and a second display electrode, a front dielectric layer covering the first display electrode and the second display electrode, a rear substrate facing the front substrate and coupled with the front substrate, an address electrode arranged on the rear substrate, a rear dielectric layer covering the address electrode, barrier ribs arranged on the rear dielectric layer, a discharge gas comprising Xe gas in cells between the barrier ribs, and a red phosphor layer, a green phosphor layer, and a blue phosphor layer arranged in the cells between the barrier ribs. The blue phosphor layer comprises two blue phosphor materials in a dual-layered structure.

The present invention also discloses a method of fabricating a PDP including forming an address electrode on a surface of a rear substrate, forming a dielectric layer covering the address electrode, forming barrier ribs on the dielectric layer, and forming a blue phosphor layer on a cell between the barrier ribs by forming a first blue phosphor layer on the dielectric layer and forming a second blue phosphor layer on the first blue phosphor layer. The first blue phosphor layer and the second blue phosphor layer are formed using two different phosphor materials.

The present invention also discloses a blue phosphor layer for a display panel, including a first blue phosphor layer including a first blue phosphor material, and a second blue phosphor layer including a second blue phosphor material. The second blue phosphor layer is formed on the first blue phosphor layer, and the first blue phosphor material and the second blue phosphor material are different phosphor materials.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic exploded perspective view showing a conventional PDP.

FIG. 2 is a cross-sectional view of a rear substrate of the PDP of FIG. 1.

FIG. 3 is a schematic cross-sectional view of a rear substrate of a PDP according to an exemplary embodiment of the present invention.

FIG. 4 is an enlarged cross-sectional view of a phosphor layer of FIG. 3.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity.

It will be understood that when an element such as a layer, film, region or substrate is referred to as being “on” another element, it can be directly on the other element or intervening elements may also be present. In contrast, when an element is referred to as being “directly on” another element, there are no intervening elements present.

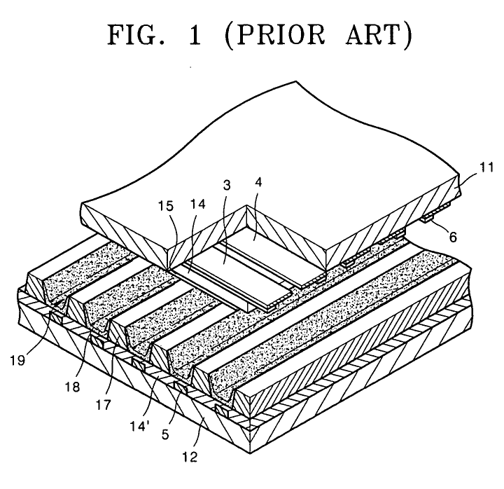

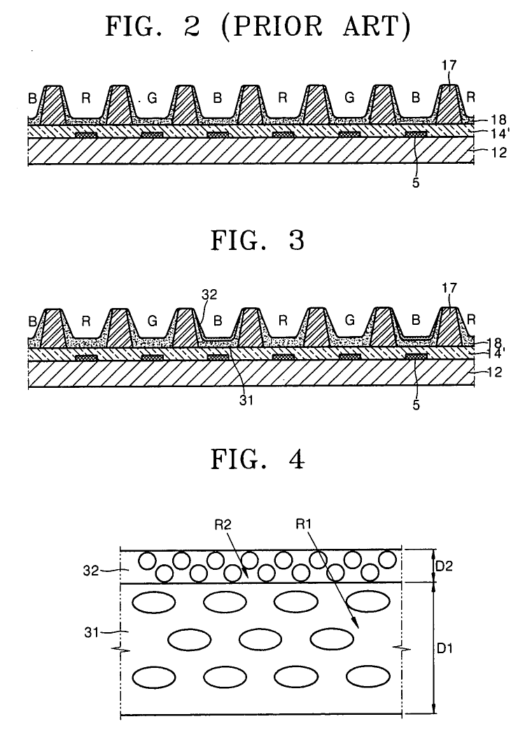

A PDP according to an exemplary embodiment of the present invention may be similar to that of the PDP of FIG. 1. Referring to FIG. 1, pairs of transparent X and Y display electrodes 3 and 4 are formed on a lower surface of a front substrate 11, and address electrodes 5 are formed on an upper surface of a rear substrate 12. A dielectric layer 14 and a protective layer 15 are sequentially formed on the lower surface of the front substrate 11. Further, barrier ribs 17, which define cells 19, are formed on an upper surface of a dielectric layer 14′ of the rear substrate 12. A discharge gas, which may be an inert gas such as Xe or Ne, is filled in the cells 19. Additionally, a phosphor material 18 is applied on sides of the barrier ribs 17 and on the dielectric layer 14′. The X and Y display electrodes 3 and 4 may include bus electrodes 6.

FIG. 3 is a schematic cross-sectional view of the rear substrate of the PDP according to an exemplary embodiment of the present invention.

Referring to FIG. 3, red R, green G, and blue B cells are formed between the barrier ribs 17 on the rear substrate 12, and the phosphor material 18 is applied on surfaces of the barrier ribs 17 and the dielectric layer 14′ forming the cells.

According to an exemplary embodiment of the present invention, the phosphor layer in the blue B cell has a dual-layered structure including two different kinds of blue phosphor materials. In FIG. 3, a first blue phosphor layer 31 includes BAM blue phosphor material, and a second blue phosphor layer 32 includes CMS blue phosphor material. The first and second blue phosphor layers 31 and 32 may be formed by printing the two different phosphor materials using masks, respectively. Since the phosphor layer 18 includes the different kinds of blue phosphor materials, the phosphor materials may correspond to the vacuum ultraviolet rays of the two different wavelengths generated by the Xe gas of the discharge gas. If the Xe gas included in the discharge gas has a high partial pressure, the blue phosphor layer of dual-layered structure including the above two kinds of blue phosphor material may improve the PDP's light emission efficiency and life span.

FIG. 4 is a schematic explanatory view showing a structure of the blue phosphor layer of FIG. 3.

Referring to FIG. 4, the first blue phosphor layer 31 includes BAM blue phosphor material at a thickness D1, and the second blue phosphor layer 32 includes CMS blue phosphor material at a thickness D2. The thickness D2 of the second blue phosphor layer 32 may be in a range of about 45 nm to about 1 μm.

In FIG. 4, R1 and R2 denote the vacuum ultraviolet rays generated by the Xe gas included in the discharge gas. R1 is a 172 nm wavelength vacuum ultraviolet ray, and R2 is a 147 nm wavelength vacuum ultraviolet ray.

Referring to FIG. 4, the 147 nm wavelength vacuum ultraviolet ray R2 is absorbed by the second blue phosphor layer 32, which includes CMS blue phosphor material, and excites the fluorescent material of the second blue phosphor layer 32. Thus, the excited phosphor material emits visible light. However, the 147 nm wavelength vacuum ultraviolet ray R2 may not permeate through the second blue phosphor layer 32, and accordingly, it may not reach the BAM blue phosphor material of the first blue phosphor layer 31. Since the 147 nm wavelength ultraviolet ray R2 may penetrate to a depth of about 45 nm, it may not permeate through the second blue phosphor layer 32 unless the second blue phosphor layer 32 is less than about 45 nm thick.

The 172 nm wavelength ultraviolet ray R1 permeates through the second blue phosphor layer 32 and reaches the first blue phosphor layer 31 of BAM blue phosphor material. The vacuum ultraviolet ray R1 excites the first blue phosphor layer 31 to emit visible light. The 172 nm wavelength vacuum ultraviolet ray R1 may penetrate to a depth of about 1 μm. Therefore, unless the thickness D2 of the second blue phosphor layer 32 exceeds about 1 μm, the 172 nm wavelength ultraviolet ray R1 may permeate through the second blue phosphor layer 32 and reach the first blue phosphor layer 31.

Hence, the thickness D2 of the second blue phosphor layer 32 may be in a range of about 45 nm to about 1 μm, and the thickness D1 of the first blue phosphor layer 31 is about 8-10 times that of the thickness D2 of the second blue phosphor layer 32. That is, the thicknesses D1 and D2 may be formed in a ratio that is in a range of about 8:1 to about 10:1.

Actually, the 147 nm wavelength vacuum ultraviolet ray R2 negatively affects the life span of the blue phosphor material, and the 172 nm wavelength vacuum ultraviolet ray R1 has less of an effect on the life span of the blue phosphor material. Particularly, the life span of BAM blue phosphor material is reduced by the 147 nm wavelength vacuum ultraviolet ray R2, however, it is less affected by the 172 nm wavelength vacuum ultraviolet ray R1. Additionally, CMS blue phosphor material, which has a relatively longer life span, is less affected by the 147 nm wavelength vacuum ultraviolet ray R2.

Therefore, embodiments of the present invention use the characteristics of the blue phosphor material and the vacuum ultraviolet ray, that is, the second blue phosphor layer 32 including CMS blue phosphor material absorbs the 147 nm wavelength vacuum ultraviolet ray R2 to emit light, and at the same time, prevents the 147 nm wavelength vacuum ultraviolet ray R1 from reaching the first blue phosphor layer 31 including BAM blue phosphor material. In other words, the second blue phosphor layer 32 prevents the 147 nm wavelength vacuum ultraviolet rays from reducing the life span of the first blue phosphor layer 31.

A PDP including the blue phosphor layer according to an exemplary embodiment of the present invention may have excellent characteristics when the Xe gas has a high partial pressure. Therefore, embodiments of the present invention are suitable for cases where the partial pressure of the Xe gas is increased to increase the PDP's light emission efficiency.

Table 1 and Table 2 show results of comparing the PDP including the blue phosphor layer according to an embodiment of the present invention to other comparative examples.

TABLE 1

| | | | Blue color | | | life span |
|---|---|---|---|---|---|---|
| | X color | Y color | brightness | | Relative | after 500 |
| | coordinate | coordinate | (cd/m²) | Efficiency | efficiency | hours |
| Embodiment 1 | 0.148 | 0.052 | 38 | 730 | 91% | 98% |
| Comparative example 1 | 0.149 | 0.06 | 47 | 783 | 98% | 90% |
| Comparative example 2 | 0.15 | 0.065 | 52 | 800 | 100% | 87% |

Embodiment 1 of Table 1 is a PDP including a blue phosphor layer having a layer of CMS blue phosphor material and a layer of BAM blue phosphor material according to an embodiment of the present invention. In Comparative example 1, CMS blue phosphor material and BAM blue phosphor material are mixed in a ratio of 9:1 to form the blue phosphor layer, and in Comparative example 2, the blue phosphor layer is formed of BAM blue phosphor material. Additionally, the partial pressure of the Xe gas is 7% for Embodiment 1 and Comparative examples 1 and 2.

In Table 1, the X color coordinate is related to red light, and the Y color coordinate is related to green light. That is, when the X color coordinate is large and the Y color coordinate is small, the red light has high color purity, and when the X color coordinate is small and the Y color coordinate is large, the green light has high color purity. Additionally, the smaller the X and Y color coordinates are, the higher the color purity of blue. However, the X color coordinate of the blue light that may be represented by visible light hardly becomes 0.145 or smaller, and accordingly, the X color coordinates of blue light according to the different kinds of phosphor materials are not largely different from each other. Therefore, the color purity of blue light is generally determined by the Y color coordinate.

Further, the efficiency means a value calculated by dividing the brightness by the Y color coordinate, and the efficiency of blue light means the affect of blue light on white light when red, green, and blue lights are all emitted to display white light. The blue light largely affects white light when the brightness and color purity are high. Therefore, in order to represent the above two characteristics by a value, the brightness is divided by the Y color coordinate and the resultant value is represented as the efficiency.

The life span is an index representing how the light emission efficiency of the phosphor material can be maintained well under various elements such as the vacuum ultraviolet ray, ion sputtering, impurities, and heat generated during the discharge when pixels of the PDP perform the discharge operation continuously. The life span is generally represented as a maintenance rate, that is, percentage of the light emission efficiency with respect to the initial light emission efficiency, after a certain time of discharge has passed.

According to Table 1, the life span of the PDP of Embodiment 1 after 500 hours has passed is higher than those of the Comparative examples 1 and 2. However, the efficiency is lower than those of the comparative examples. That is, when the partial pressure of the Xe gas included in the discharge gas is 7%, the efficiency is less improved than the life span. Actually, the life span may be increased when the partial pressure of the Xe gas is 5% or larger.

TABLE 2

| | | | Blue light | | | Life span |
|---|---|---|---|---|---|---|
| | X color | Y color | brightness | | Relative | after 500 |
| | coordinate | coordinate | (cd/m²) | Efficiency | efficiency | hours |
| Embodiment 2 | 0.148 | 0.049 | 46 | 938 | 97% | 99% |
| Comparative example 3 | 0.149 | 0.057 | 43 | 754 | 78% | 93% |
| Comparative example 4 | 0.15 | 0.062 | 60 | 967 | 100% | 91% |

Embodiment 2 of Table 2 is a PDP including the blue phosphor layer formed of a layer of CMS blue phosphor material and a layer of BAM blue phosphor material according to an embodiment of the present invention. In Comparative example 3, CMS blue phosphor material and BAM blue phosphor material are mixed in a ratio of 9:1 to form the blue phosphor layer, and in Comparative example 4, the blue phosphor layer is formed of BAM blue phosphor material. Additionally, the partial pressure of the Xe gas included in the discharge gas is 15% in Embodiment 2 and Comparative examples 3 and 4.

As Table 2 shows, the second embodiment of the present invention may have improved efficiency or nearly the same efficiency as those of the comparative examples, as well as an improved life span after 500 hours. That is, the second embodiment of the present invention may be suitable for a case where the partial pressure of Xe gas included in the discharge gas is relatively high. Furthermore, when the partial pressure of the Xe gas is 20% or less, the life span and the light emission efficiency may be improved.

According to exemplary embodiments of the PDP and the method of fabricating the PDP of the present invention, the blue phosphor layer includes a CMS blue phosphor material layer and a BAM blue phosphor material layer, thereby increasing the PDP's light emission efficiency and life span. Additionally, the PDP may have excellent characteristics when the Xe gas has high partial pressure.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma display panel (PDP), comprising:
a front substrate including a first display electrode and a second display electrode;
a front dielectric layer covering the first display electrode and the second display electrode;
a rear substrate facing the front substrate and coupled with the front substrate;
an address electrode arranged on the rear substrate;
a rear dielectric layer covering the address electrode;
barrier ribs arranged on the rear dielectric layer;
a discharge gas comprising Xe gas in cells between the barrier ribs; and
a red phosphor layer, a green phosphor layer, and a blue phosphor layer arranged in the cells between the barrier ribs,
wherein the blue phosphor layer comprises two blue phosphor materials in a dual-layered structure.

2. The PDP of claim 1, wherein the blue phosphor layer comprises a first blue phosphor layer comprising Ba Mg Al₁₀O₇ and a second blue phosphor layer comprising Ca₂ Mg SiO₆, and the second blue phosphor layer is arranged on the first blue phosphor layer.

3. The PDP of claim 2, wherein a thickness of the second blue phosphor layer is in a range from about 45 nm to about 1 μm.

4. The PDP of claim 1, wherein a partial pressure of the Xe gas is in a range from 5% to 20%.

5. The PDP of claim 2, wherein the first blue phosphor layer is about 8 to 10 times thicker than the second blue phosphor layer.

6. A method of fabricating a plasma display panel, comprising:
forming an address electrode on a surface of a rear substrate;
forming a dielectric layer covering the address electrode;
forming barrier ribs on the dielectric layer; and
forming a blue phosphor layer on a cell between the barrier ribs by forming a first blue phosphor layer on the dielectric layer and forming a second blue phosphor layer on the first blue phosphor layer,
wherein the first blue phosphor layer and the second blue phosphor layer are formed using two different phosphor materials.

7. The method of claim 6, wherein the first blue phosphor layer comprises Ba Mg Al₁₀O₇, and the second blue phosphor layer comprises Ca₂ Mg SiO₆.

8. The method of claim 6, wherein a thickness of the second blue phosphor layer is in a range from about 45 nm to about 1 μm.

9. The method of claim 6, wherein the first blue phosphor layer is about 8 to 10 times thicker than the second blue phosphor layer.

10. A blue phosphor layer for a display panel, comprising:
a first blue phosphor layer comprising a first blue phosphor material; and
a second blue phosphor layer comprising a second blue phosphor material, the second blue phosphor layer being formed on the first blue phosphor layer,
wherein the first blue phosphor material and the second blue phosphor material are different phosphor materials.

11. The blue phosphor layer of claim 10, wherein the first blue phosphor layer comprises Ba Mg Al₁₀O₇, and the second blue phosphor layer comprises Ca₂ Mg SiO₆.

12. The blue phosphor layer of claim 11, wherein a thickness of the second blue phosphor layer is in a range from about 45 nm to about 1 μm.

13. The blue phosphor layer of claim 11, wherein the first blue phosphor layer is about 8 to 10 times thicker than the second blue phosphor layer.
